(19) United States
(12) Patent Application Publication
(10) Pub. No.: US 2010/0287047 A1
(43) Pub. Date: Nov. 11, 2010

(54) Calling Banners

(76) Inventors: Shai David Zohar, Tel Aviv (IL); Ido Eli Zohar, Tel Aviv (IL)

Correspondence Address: The Law Office of Michael E. Kondoudis, 888 16th Street, N.W., Suite 800, Washington, DC, 20006, US

(21) Appl. No.: 12/812,257

(22) PCT Filed: Jan. 8, 2009
(86) PCT No.: PCT/IL09/00025

§ 371 Date: Jul. 9, 2010

Related U.S. Application Data
(60) Provisional application No. 61/006,378, filed on Jan. 10, 2008.

(51) Int. Cl. G06Q 30/00; G06F 17/30; G06F 3/048; H04W 4/00

(52) U.S. Cl. 705/14.41; 705/14.4; 705/14.49; 707/802; 715/780; 455/414.1; 707/E17.044; 715/764

(57) ABSTRACT

A system, a method and an ad banner for enabling an advertiser to initiate communication with at least one user, using the ad banner, which is associated with the advertiser. The ad banner includes a calling tool, enabling to initiate a call between the user and the advertiser, where the calling tool is activated and deactivated according to predefined rules including at least one activation condition, according to which the calling tool can be activated.

### CROSS REFERENCE TO RELATED APPLICATION

This application claims the benefit of U.S. Provisional Patent Application No. 61/006,378, filed Jan. 10, 2008, which is incorporated herein by reference in its entirety.

### BACKGROUND

1. Field of the Invention

The present invention relates generally to the field of ad banners and more particularly to ad banners with telephonic solutions.

2. Related Art

Ad banners or web banners are a form of electronic advertising (e.g. a software code), which enables embedding the ad into a network page such as a web page. The banners are intended to attract users who view network pages in which the banners are embedded. The same banner may be embedded in more than one page of more than one website or communication network and adaptations may be made to adapt the banner to the network or the website pages definitions and requirements.

An ad banner may be a rich media file comprising audio, graphic, video and/or animation advertising content, employing content technologies such as, for example, Java, Silverlight, Flash, Shockwave and the like, as known in the art.

The banner may be embedded into the page according to predefined rules or conditions. For example, banner's content may only appear when the user moves the cursor (using the computer mouse or the keyboard for example) via a predefined area on the page screen, or clicks a predefined area on the page and/or other conditions as known in the art.

The banner, appearing on a web page of one or more external websites, usually redirects to the advertiser's website (referred to hereinafter as the “source website”). Banners are usually distributed by an ad server, which embeds the banner in the external websites, according to various parameters such as the characteristics of the external website audience, the type of technology being in used by this website and the way in which the interaction with the banner should be counted and stored.

### SUMMARY

The present invention, according to some embodiments thereof, provides a system, a method and an ad banner for enabling an advertiser to initiate communication with at least one user, using the ad banner, which is associated with the advertiser. The ad banner may include a calling tool, enabling to initiate a call between the user and the advertiser, where the calling tool is activated and deactivated according to predefined rules including at least one activation condition, according to which the calling tool can be activated. The calling application may be implemented as an independent layer within the banner, which does not interfere in the banner's original functioning.

According to some embodiments of the invention, the system may comprise:
at least one external network page comprising at least one ad banner of the advertiser, wherein the banner is embedded and is positioned in said network page;
at least one central server enabling maintaining and updating the ad banner;
at least one user's communication device of at least one user; and
at least one advertiser's communication device.

According to some embodiments of the invention, the ad banner may comprise advertising content and a calling tool, wherein the calling tool may enable initiating a call between the advertiser's communication device and the user's communication device.

According to some embodiments of the invention, the system may allow activating and deactivating of the calling tool, according to predefined rules, which include at least one activation condition enabling to activate the calling tool upon validation of the fulfillment of said at least one activation condition. Such activation conditions may be either fulfilled by a server or by a client, which may be a user's computerized communication device, or by both server and client according to conditions' definitions.

According to some embodiments of the invention, the method may comprise:

verifying the fulfillment of at least one predefined activation condition;

activating said calling tool, by activating the calling tool, wherein said calling tool is activated once said at least one activation condition is verified; and

initiating a call between a user's communication devices and an advertiser's communication device once a user approves said initiation.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a block diagram schematically illustrating a system for supporting ad banners with add-on calling tools, according to some embodiments of the invention;

FIG. 2 is a flowchart, schematically illustrating a method for activation and initiation of a call through ad banners, according to some embodiments of the invention;

FIG. 3 is a block diagram, schematically illustrating an ad banner with an input interface, according to some embodiments of the invention;

FIG. 4 is a flowchart, schematically illustrating a method for activation and initiation of a call through a banner's input interface, according to some embodiments of the invention; and

FIG. 5 is a block diagram, schematically illustrating a banner customization tool, according to some embodiments of the invention.

The drawings together with the description make apparent to those skilled in the art how the invention may be embodied in practice.

### DETAILED DESCRIPTION OF SOME EMBODIMENTS OF THE INVENTION

The present invention, in some embodiments thereof, provides a system 1000, a method and an ad banner 100 comprising advertising content 110 that can be incorporated with an add-on calling tool 120.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

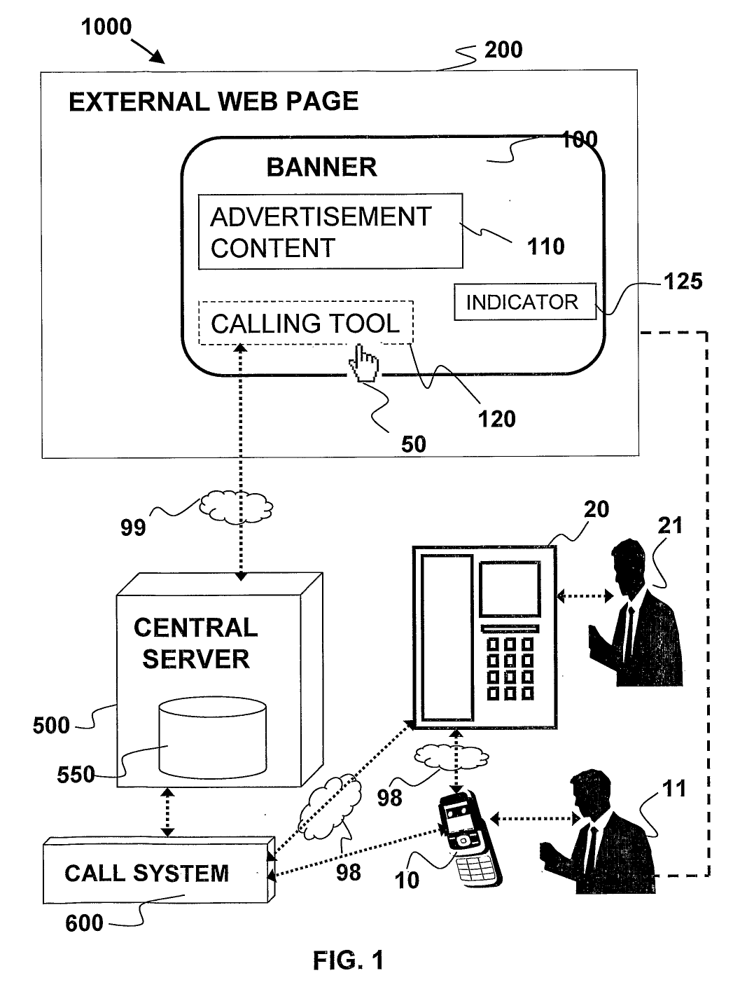

Reference is now made to FIG. 1, which schematically illustrates a system 1000 for enabling operating and presenting of ad banners 100 with a calling applicability, according to some embodiments of the invention. According to these embodiments, the system 1000 may comprise at least some of an external web page 200 associated with a website; at least one banner 100; at least one central server 500; at least one database 550; at least one advertiser's communication device 20; at least one call system 600 and at least one user's communication device 10.

According to some embodiments of the invention, as illustrated in FIG. 1, the banner 100 may be embedded in the network page 200. The banner 100 may comprise advertising content 110 and an add-on calling tool 120.

According to some embodiments of the invention, the advertising content 110 may be presented in the banner 100 in any media and method known in art (such as aural, visual, textual, animated, graphical and the like). The content may be any known computer code/script employing any content technology known in the art such as, for example, Java, Silverlight, Flash, Shockwave and the like.

According to some embodiments of the invention, as illustrated in FIG. 1, the calling tool 120 may enable initiating a call between a predefined advertiser's communication device 20 and at least one user's communication device 10, where the calling tool 120 can be activated, deactivated, presented or removed, according to at least one predefined activation condition. The calling tool 120 may be activated in the banner 100 according to predefined rules, which include at least one activation condition enabling to activate the calling tool 120 upon validation of the fulfillment of the at least one activation condition.

According to some embodiments of the invention, once the calling tool 120 is activated a visual indicator 125 may be presented (such as a bubble). The visual indicator 125 may enable the user 11 to enter an interface enabling the user to enter the calling tool 120 by triggering the indicator 125.

According to some embodiments, the indicator 125 may be triggered by the user 11 by, e.g. only when the user hovers with the cursor over the indicator (e.g. bubble) or by clicking in the area of the indicator. Upon triggering, the entire calling tool 120 may be presented to the user 11.

The activation condition(s) for activating and deactivating the calling applicability and the calling tool 120 may be any condition(s) predefined in the system 1000 which may be for example: (A) conditions depending on events that are carried out by the user 11 such as, for instance, at least one of: (1) the network page which the user 11 uses (at any given moment); (2) information relating to the user such as misuse of previous calling applicability; or (3) exceeding a predefined threshold quota of calls; (B) conditions depending on events that are predefined by the advertiser 21 such as, for example (1) a predefined scheduling defined by the advertiser 21; (2) the advertiser's 21 state of account; (3) maximum calls approved to be received by the advertiser 21 in a predefined time-interval (e.g. per day) etc.; (4) maximal number of connected calls (C) and/or any other conditions (either automotive or interactive) enabling to activate and deactivate, present and/or hide the calling tool 120 and thereby enabling and disabling (respectively) the ability of the tool 120 to and initiate communication between the user 11 and the advertiser 21 (e.g. by initiating a call between their devices 10 and 20).

The advertising content 110 of the banner 100 may be presented whereas the calling tool 120 indicator 125 (e.g. icon, options and the like) may only be presented or displayed once the calling tool 120 is activated (meaning once the activation condition(s) are verified). This means that the banner 100 may have dual functioning: the banner 100 may behave as a regular banner, without any presence of the calling tool 120, or as a “calling banner”, allowing both the original ad content 110 and the calling tool 120 to be available for the user 11. The indicator 125 for indicating the calling tool 120 is optional, In case that the calling tool's 120 interface may not be displayed onto banner 100 in order to avoid hiding the ad content 110.

The ad banner 100 may be any electronic banner known in the art such as a web banner, which is a software application (code) that can be embedded into external network pages 200 such as web pages of the internet or any other communication network 99. The banner 100 may be embedded in the page 200 according to various embedding methods known in the art.

Additionally or alternatively, the banner 100 as a whole or the calling tool 120 as an independent part of the banner 100 may have a turning-off option for disabling the banner 100, and/or the calling tool 120.

Each ad banner 100 may be embedded in one or more network pages 200 (e.g. web pages 200) associated with one or more websites and one or more types of web pages 200 and/or communication networks 99. Furthermore, multiple banners 100 may be distributed in a multiplicity of network pages 200, being operated and controlled, for example, by at least one ad-server as known in the art, while the calling tools 120 in each banner 100 may be subject to a centralized control server 500 over network 99 in the system 1000 regarding the activation of the calling tool 120.

The user 11 may be any user 11 using one or more communication networks 99 that can use and view network pages 200 with banners 100 embedded therein.

The advertiser 21 may be any entity that publishes through the banners 100 and/or that maintains the banners 100 and embed them in various pages 200 such as a business, a company, one or more persons and the like, as known in the art.

The communication devices 10 and 20 may be any communication devices known in the art enabling communication through one or more communication networks 98 and/or 99 comprising means for handling a voice conversation. In some cases it may be that the communication device 10 is also capable of viewing and interacting with the banner 100 by surfing, browsing and using the device 10 and 20 for retrieving, inputting and viewing of data or any other functionality known in the art enabling to retrieve and input information (e.g. video, audio, visual display and the like). In such cases, communication networks 99 and 98 may be the same communication network (e.g. the internet) enabling for both interaction with the banner 100 and handling of the voice conversation with communication devices 10 and 20. For example, each device 20 or 10 may be at least one of: a PC computer, a laptop with internet access, a mobile phone with WAP access, an iPhone, an i-pod and the like, using any communication and interface technologies known in the art.

Additionally or alternatively, the networks 98 and 99 used for communication between the user/advertiser 11/21 with the network page 200 and for communication between the user 11 and the advertiser 21 may be different depending on the communication devices 10 and 20, respectively, used by the user 11 and advertiser 21 to carry out the call.

The banner 100, appearing on a network page 200 of one or more external websites, may direct to the advertiser's website or mini-site as known in the art (referred to hereinafter as the “source website”) when the user clicks on the banner 100 or carries out any other function predefined in the system 1000 (e.g. through a link). The banner 100 may be maintained by an advertiser's central web server, or an external server like ad-network server as known in the art, which manages the operation and distribution of the advertiser's 21 one or more banners 100 through a variety of external websites and their web pages 200.

The server 500 may be operatively associated with the network page 200, the banner 100, the advertiser's communication device 20 and with at least one database 550 enabling to store data relating to the initiated calls, registered advertisers 21 and their devices 20, and enabling advertisers 21 or any other authorized user to retrieve data stored therein.

According to some embodiments, the server 500 is not connected directly to the advertiser's communication device 20 but rather to at least one communication operator (such as the call system 600) enabling to initiate a call between the user 11 and the advertiser 21. For example, the communication operator may be a wireless or wire telephony communication operator that includes a list of telephone numbers enabling to initiate calls between the advertiser's communication device 20 to the user's communication device 10 using their phone numbers from the list.

According to some embodiments of the invention, the central server 500 may additionally enable maintaining a multiplicity of ad banners 100 with add-on calling tools 120 associated with one or more advertisers 21. The server 500 may additionally enable advertisers 21 to register and open an account from which they can pay for the maintenance of the calling tools 120 in their banner(s) 100, control the features of the calling tool 120 in their banner(s).

According to some embodiments of the invention, the system 1000 may further comprise at least one call system 600 (e.g. an operator of one or more communication networks 98), which may be operatively associated with the server 500 enabling to transmit data to the server 500 and thereby update the server 500 regarding calls and accounts related information such as parameters indicating the traffic loads, the users' 11 call length and status and/or any other communication devices' addresses and sources and the like, as known in the art.

According to some embodiments of the invention, all activation conditions may be checked by the server 500, where the server 500 may validate or invalidate the activation of the calling tool 120 according to predefined rules and priorities (e.g. advertisers 21 that are in monetary debt may be a first priority for deactivating their calling tools 120 or calls to advertiser 21 over the network 98 reach a predefined maximum limit etc.).

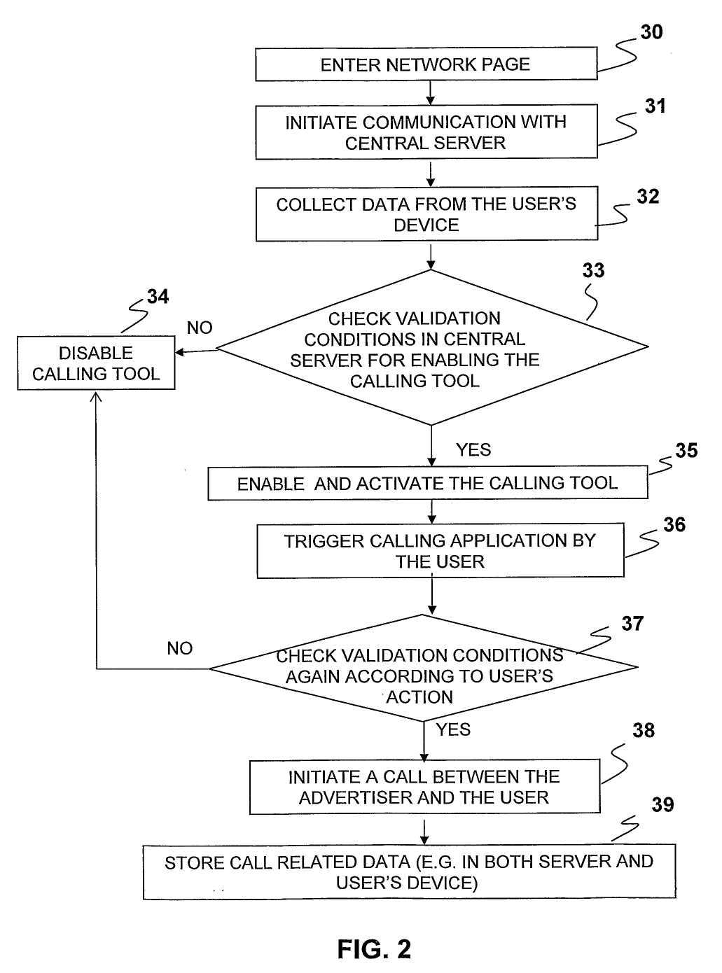

Reference is now made to FIG. 2, which schematically illustrates a process of activating of the calling tool 120 of a banner 100 and the initiation of a call, according to some embodiments of the invention. According to these embodiments the process may comprise the steps of:

entering the network page that comprises the ad banner 30, wherein the user 11 enters the network page;

initiating communication with the central server 500 and reporting to the server 31;

collecting data from user's device 32 (for example—the device's IP address, geographical location, referral domain address, former history stored at client-side of user's telephone calls via the calling tool 120 etc);

checking initial validation condition(s) 33 for presenting the calling tool 120 according to predefined rules (e.g. the advertiser's 21 schedule or max concurrent-calls limit);

deactivating the calling tool 34, once the validation check results in a non-validated activation or no communication with the server 500;

activating the calling tool 35, once the validation check results valid;

triggering the calling applicability 36 (carried out by the user 11, who may perform a triggering action such as clicking the calling tool 120 and/or inserting his/her communication code (e.g. phone number));

Checking initiation condition 37 according to the user's 11 actions (e.g. upon inputting the user's phone number); and

Initiating a call between the user and the advertiser 38 (upon fulfilling the initiation conditions).

According to embodiments, additional actions may be taken during/after the call is initiated such as, for example, collecting and storing call related data 39 (see FIG. 2) in the server 500 or at the user's client, while the call is executed, for later billing and calls' history analysis (e.g. the duration of the call, the time and date of the call, etc.), adding information to the accumulative learning of the system (such as user's behavior) and/or storing client-side information in the user's client in order to allow automatic future interaction with the banner 100 (phone-numbers that resolved in a short unsuccessful calls, remembering last phone number typed by user for future one-click-to-call interaction).

According to some embodiments of the invention, the user's communication device 10 may be the computer he/she uses to enter the network page 200, where the advertiser's communication device 20 details are registered in the server 500 enabling to initiate communication between the devices 10 and 20 by executing a Voice over IP (VoIP) technology, for example, enabling automatic communication through the banner 100 or through the source website of the advertiser 21 linked by the banner 100. In a case, in which the user's communication device 10 is a fixed line telephone handset, or a mobile handset that has not been used for the interaction with the banner 100, a callback procedure may be used in order to connect the advertiser's telephone handset 20 and the user's telephone handset 10 by calling one handset, then calling the other handset and then connecting both handsets, as known in the art. The order in which both handsets are called (which one is first) may be a case-specific parameter which is stored at database 550 and delivered by sever 500.

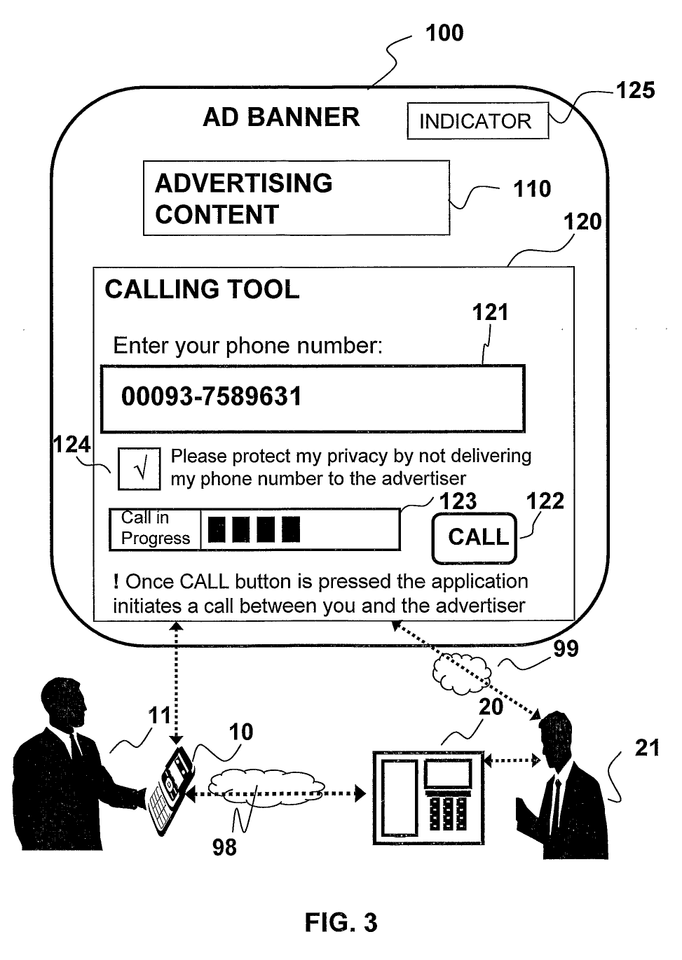

Reference is now made to FIG. 3, which schematically illustrates an ad banner 100 with a calling tool 120, according to some embodiments of the invention.

According to these embodiments, the calling tool 120 may comprise an interface comprising an input field 121 (e.g., a text field that may be utilizing an internet cookie), a virtual call button 122, and a call progress indicator 123. The input field 121 may allow the user 11 to input his/her communication code such as his/her phone number and pressing the call button 122 may allow the user 11 to approve the call. According to embodiments, the banner 100 may further include a visual indicator 125, which may be displayed when the calling tool 120 is active. The indicator 125 may be an interactive object within banner 100 that may trigger the calling tool's 120 interface including, for example, the input field 121, the virtual call button 122, the call progress indicator 123 etc.

According to embodiments, the last inputted communication code, entered by the user 11 into the input field 121, which includes the communication details required for establishing communication with the user's communication device 10 (e.g. phone number, VoIP account identifier, etc.) may be stored and automatically reappear in the input field 121. Such storing may allow for the identifier to become a default option for the input field 121 in other banners 100 of other advertisers 21, as long as the user 11 is using the same client device (such as a personal computer).

According to embodiments, a web cookie may enable checking the user's 11 validity (e.g. whether this is a problematic user 11 defining the user as “invalid” in the system according to predefined user-invalidation rules), for example, using the user's input communication code or the result and length of former calls made using the calling-tool 120.

According to some embodiments of the invention, as illustrated in FIG. 3, once the user 11 inputted his/her phone number and pressed the call button 122, the system 1000 may allow automatically initiating a call between the advertiser's communication device 20 and the user's 11 phone (as the user's communication device 10). For example, the call may be carried out by the call system 600 enabling to execute a call from the advertiser's communication device 20 to the user's communication device 10 through any communication network(s) 98, for example at the expense of the advertiser 21. Such call initiation may be the result of an automatic decision-making process, carried out by the server 500 based on data stored in database 550 and possibly additional data that may be provided by the calling tool 120 to the server 500 (for example, data relating to the client, such as previous call history, timing etc), while such decision-making process may further include rules related to the advertiser 21, the timing of the call and other circumstances. The call initiation may be, in some embodiments of the invention, subject to user's 11 choices in regard to the exposure of his phone number to the advertiser 21. For example, as illustrated in FIG. 3, the calling tool 120 may contain a check-box 124 related to user's 11 privacy, in which the user 11 can mark his choice in that respect. As further illustrated in FIG. 3, the call initiation may be monitored by a visual notification to user 11 in regard to the progress of the call and/or the call connection. The call initiation may be subject to a decision process.

The call progress indicator 123 may facilitate in indicating the communication status and progress, as known in the art, once the call is initiated.

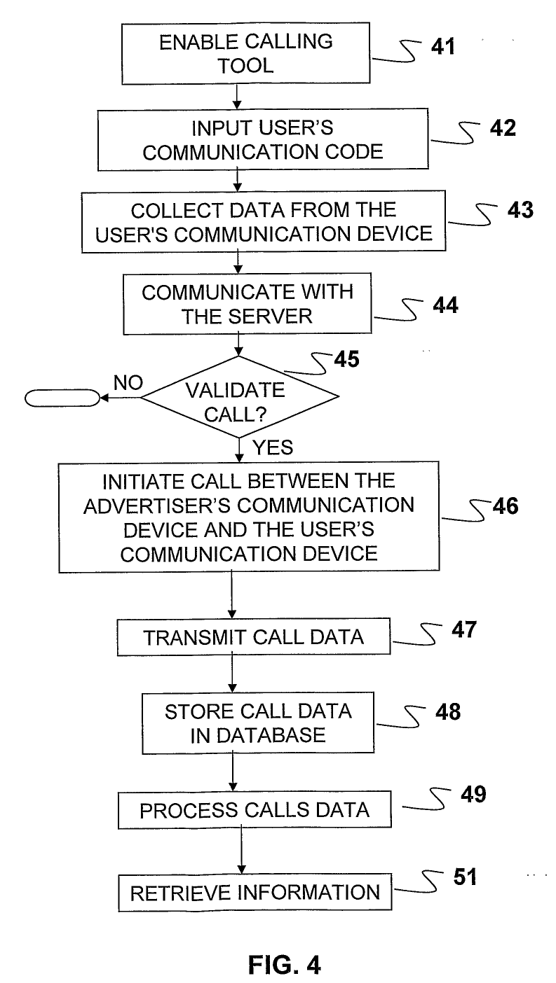

Reference is now made to FIG. 4, which schematically illustrates a process of initiating a call to the user's communication device 10, according to some embodiments of the invention. According to these embodiments, the process may comprise the steps of:

activating the calling tool 41, where the user 11 triggers the tool 120 (e.g. by hovering over a predefined area on the screen page of the network page 200, for example, a predefined area within banner 100, with the cursor 50);

Inputting the user's communication code (e.g. phone number) 42, where the user enters his/her communication code into the input field 121;

Collecting data stored at user's client 43, for example, by utilizing a cookie as known in the art, for complementary information in regard to the approval of the call;

Communicating with the server 44 including retrieving information from database 550 in order to gather all information required for the decision-making process relating to the call initiation validation;

Once the call is approved 45 (e.g. when the call button is pressed by the user 10 and no reason has been found in system 1000 for invalidating the call)—initiating a call 46 from the advertiser's communication device 20 to the user's communication device 10;

Transmitting call data 47. where the call system 600 enables transmitting the call data (e.g. phone number, call length, call status, other details, time parameters, results of the call in sales terms and the like) to the server 500;

Storing the call data 48 where the server 500 stores the data in the database 550; and

Processing calls data 49, where the server 500 enables processing all the call data stored (e.g. using statistical modules to process the data associated to the advertiser 21 to output statistics enabling the advertiser user to measure the efficiency of the banner 100 as a sales promoter and the like); and

Retrieving information from the database 51, where the system 1000 allows authorized users and/or advertisers 21 to retrieve and view the resulting processing results (E.g. the statistical information of each banner 100 embedded in each network page 200).

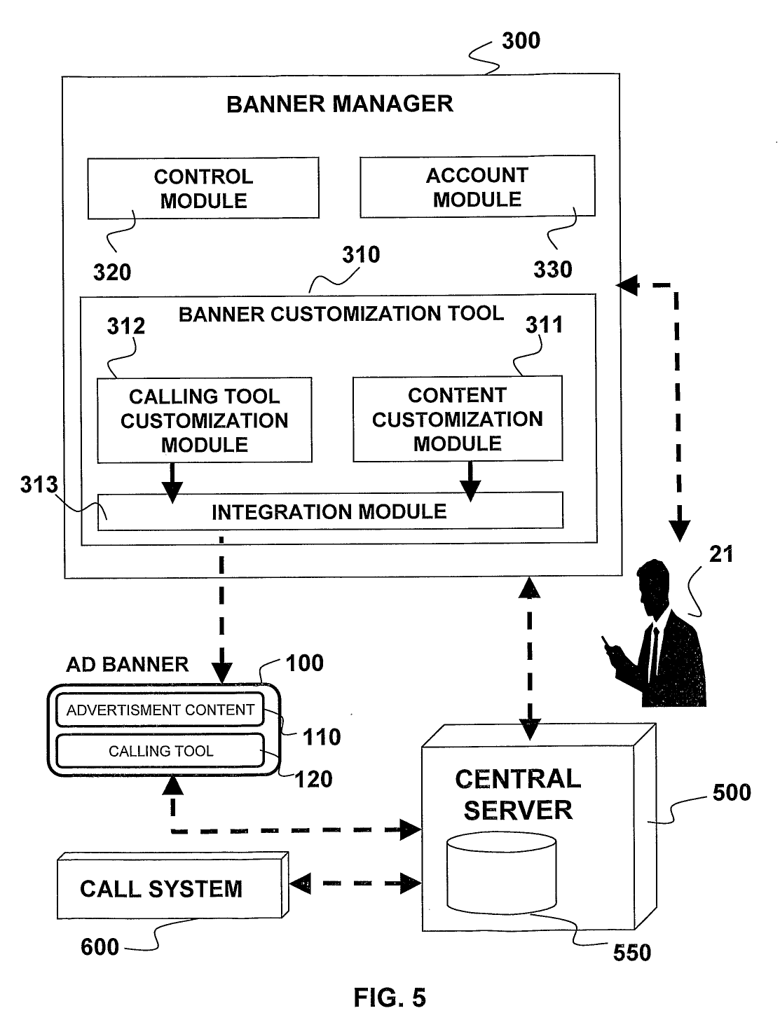

Reference is now made to FIG. 5, which schematically illustrates a banner manager 300, according to some embodiments of the invention. The banner manager 300 may be any software tool (e.g. a website) that allows a multiplicity of advertisers 21 to create, manage and customize their banners 100 or specifically their banner's 100 calling tools 120.

According to some embodiments of the invention, as illustrated in FIG. 5, the banner manager 300 may comprise at least one of: a banner customization tool 310 comprising a content customizing module 311, a calling tool customizing module 312 and an integration module 313; a control module 320; and an account module 330.

The banner customization tool 310 may enable advertisers 21 to create, customize and update their banners 100 and/or the calling tools 120 including defining and updating the details related to utilizing communication networks 98 and configurations for executing and initiating of calls from and to a variety of communication devices 10 and 20.

According to some embodiments of the invention, the content customization module 311 may enable the advertiser 21 to create, customize and/or update the content of the advertisement in the banner 100. For example, define an existing banner file to be used as the advertising content 110 and/or edit or add to its content (e.g. add the texts, create animated films, add audio and/or graphic messages and the like).

According to some embodiments of the invention, the calling tool customization module 312 may enable the advertiser 21 to create, update and/or customize the calling tool 120 and the features and parameters of the calling tool 120 such as defining or selecting the activation conditions, defining the graphics of the calling tool 120, defining the appearance and graphics of the indicator 125 of the calling tool 120, defining the types of communication networks 98 and devices 20 available to the advertiser 21, inputting and updating the destination phone number or identification and communication details of the advertiser's communication device(s) 20 and the like.

According to some embodiments of the invention, the integration module 313 may enable integrating the calling tool 120 together with the advertising content 110 in the banner 100, according to the customization made by the advertisers as well as according to the configuration requirements of different ad networks and publisher webpages. The integration module 313 may further enable automatically updating, creating and/or customizing the banner 100 with respect to its content and the calling tool 120 for presenting it in the network page 200 according to the customization made by the advertisers 21 as well as according to the configuration requirements of each network page 200.

The banner customization tool 310 may use GUI applications to allow graphical and audio editing and creating tools. Additionally or alternatively, definitions and settings may be communicated to the banner customization tool 310 without a GUI, for example using an Internet web-service or configuration files loaded or downloaded to it.

According to some embodiments of the invention, the control module 320 may be associated with the banner customization tool 310 and with the central server 500 enabling to monitor and supervise the banners 100 made by the banners customization tool 310 and the calls initiated by the calling tool 120 (e.g. receive statistics about the calls/clicks/impressions of the banners, activate/deactivate the calling tool in each published banner 100, edit its settings, associate banners in groups, etc).

According to some embodiments of the invention, the account module 330 may be a user interface enabling the advertiser 21 to open and manage a personal account comprising all banners' associated with the advertiser 21, pay for the services of the banner customization tool 310 and/or the calls made by the calling tools (or by other techniques known in the art, such as paying for banners impressions, leads, minutes talked, click-through) of the banners 100, and the like. Additionally, the account manager 330 may further enable managing the accounts of all advertisers 21 and transmit the monetary condition of each advertiser 21 to the server 500 to allow it to calculate and consider this data as at least some of the activation conditions.

The system 1000 may allow upgrading already existing and designed banners of advertisers 21 that do not include the calling applicability and the calling tool 120 by integrating the code of the calling tool 120 into the banner 100 file (e.g. flash file). This may be carried out using any codes and applications integration technologies, depending of the computer program language and features of each banner 100, such as a method and system described in Patent Application No. 61/006,379, filed Jan. 10, 2008, which is incorporated by reference herein in its entirety.

According to some embodiments of the invention, once the calling tool 120 is activated a visual indicator 125 may be presented (such as a bubble). The visual indicator may enable the user 11 to enter an interface enabling the user to enter the calling tool 120 by triggering the indicator.

According to some embodiments, the indicator may only be triggered by the user by, e.g. only when the user hovers with the cursor over the indicator (e.g. bubble) or by clicking in the area of the indicator.

According to some embodiments of the invention, each banner 100 may be a rich media file comprising three sets of computer codes: a first code set enabling to define and control the advertising content 110 and presentation features such as the banner's 100 display area in the page screen according to limitations and definitions of the specific network page 200, graphical features and the like; a second code set enabling to control the calling applicability and the display and other features of the calling tool 120; and a third code set enabling to control the incorporating and integrating of the calling tool 120 into the banner 100 according to the activation conditions and, in cases where the entire banner 100 presentation is changed upon activation and deactivation—the third code set may enable controlling the presentation change and its parameters and features (e.g. graphical parameters and display features).

According to some embodiments of the invention, the third code set may enable establishing and executing internet communication (e.g. through text messages or VoIP) between the user 11 and the advertiser 21 (where the communication devices 10 and 20 enable internet and/or VoIP communication, for example).

According to embodiments, the system 1000 may further enable a multiplicity of advertisers 21 to share information regarding potential customers, by allowing analyzing stored data such as: user's communication codes user's phone number (allowing a single-click phone-call initiation), history of calls, history of the quality of calls (e.g. supporting fraud and miss-use analysis by storing prior call status and duration at the client machine) etc.

According to embodiments, the system 1000 may further enable the advertiser 21 and/or any other user (e.g. authorized user) to manually convert the status of the banner 100 from an non-calling banner 100, having no calling applicability into a calling banner 100 and vice versa (a calling banner into a non-calling banner).

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

1. A system for enabling initiating communication between an advertiser and at least one user, said system comprising:
an ad banner associated with the advertiser, wherein the banner is embedded in at least one network page;
at least one central server enabling maintaining and updating said ad banner;
at least one user's communication device of at least one user; and
at least one advertiser's communication device;
wherein said ad banner comprises advertising content and a calling tool,
wherein said calling tool enables initiating a call between the advertiser's communication device and the user's communication device,
wherein said system allows activating and deactivating the calling tool according to predefined rules, which include at least one activation condition enabling to activate the calling tool upon validation of the fulfillment of said at least one activation condition.

2. The system of claim 1, wherein the at least one activation condition is at least one of: conditions depending on events that are carried out by the user, conditions depending on events that are predefined by the advertiser.

3. The system of claim 1, wherein said central server is operatively associated with at least one database enabling to store data relating to the initiated calls, registered details relating to advertisers and their communication devices, and enabling authorized advertisers to retrieve data stored therein.

4. The system of claim 2, wherein said activation conditions that relate to the advertiser include at least one of:
a pre-paid balance of the advertiser's account;
a predefined calling schedules defined by the advertiser;
calls-traffic loads; and
user's geographical location.

5. The system of claim 2, wherein said activation conditions that are dependent on events that are carried out by the user, include at least one of:
a suspicious banner;
history of problematic utilizing of calling applications;
geographical location of the user;
the number of time the banner has been loaded;
exceeding a predefined threshold quota of calls in the specific banner.

6. The system of claim 1, wherein said central server is further operatively associated with at least one calling system, enabling to execute phone calls via the at least one communication network and to transmit data to said central server and thereby update the central server regarding calls and accounts related information, wherein said server enables advertisers to open, customize and define personal accounts enabling advertisers to define, create, upload and customize banners, customize calling tools and their content, prepay for calls and view statistical data relating to calls made through their banners, and
wherein said call system is a communication operator enabling to store and transmit data relating to calls carried out between the user's communication device and the advertiser's communication device through at least one communication network wherein said calls are initiated by the calling tool of the banner as well as regarding advertisers' account balances and other account related details.

7. (canceled)

8. The system of claim 1 is associated with a banner manager, wherein said banner manager comprises at least one of:
a banner customization tool;
a control module; and
an account module,
wherein the banner customization tool enables the advertiser to create, update customize banners and, enables defining and updating the communication networks and configurations for executing and initiating of calls from and to a variety of communication devices; wherein the control module enables monitoring and supervising the banners made by said customization tool; and the account module is a user interface enabling the advertiser to open and manage a personal account comprising all data associated with the banners of the advertiser, storing and updating statistical calls data related to the advertiser, pay for the calling and advertising services of the banner.

9. (canceled)

10. (canceled)

11. The system of claim 8, wherein the banner customization tool further comprises a calling tool customizing module, wherein the calling tool customization module enables the advertiser to create, update and customize the calling tool and the features and parameters of the calling tool.

12. (canceled)

13. (canceled)

14. (canceled)

15. (canceled)

16. The system of claim 1, wherein the calling tool comprises an interface comprising: an input field allowing the user to input the identification of his communication device; and a virtual call button, which allows the user to approve the call by pressing said button, wherein upon pressing said button a call is automatically initiated.

17. The system of claim 1, wherein once the calling tool is activated, a visual indication, indicating the activated status of the calling tool, is presented and wherein said triggering enables the user to enter an interface to initiate a call from the interface by triggering the indicator, wherein said triggering includes on of: hovering with a cursor over the indicator; clicking upon the indicator area.

18. (canceled)

19. The system of claim 17, wherein said interface stores and retrieves a user's identifier of the user's communication device for initiating a call with the user, where the last identifier that was entered to said interface of any banner associated with said server is used as a default option for the user's identifier.

20. A computer implemented method of activating and deactivating a calling tool within at least one ad banner of an advertiser, wherein said banner is embedded in at least one network page, wherein said calling tool enables initiating a call between the advertiser and a user, said method comprising:
verifying the fulfillment of at least one predefined activation condition;
activating said calling tool, once said at least one activation condition is verified; and
initiating a call between a user's communication devices and an advertiser's communication device once a user triggers said initiation.

21. The method of claim 20 further comprising checking at least one predefined validation condition according to predefined rules, wherein said calling tool is activated only once said activation conditions are validated.

22. The method of claim 20 wherein at least one central server communicating with said banner enables verifying the activation conditions and activate and deactivate the calling tool, according to the activation conditions.

23. The method of claim 22, wherein said initiation of said call is carried out by enabling the advertiser's communication device to automatically call the user's communication device through at least one communication network at the expense of the advertiser.

24. The method of claim 23 further comprising transmitting calls related data to the central server, wherein a call system operatively associated with said server enables initiating calls and transmitting call related data to said server, wherein said server is operatively associated with at least one database enabling to store said data.

25. The method of claim 24 further comprising:
processing calls data, wherein the central server enables processing the calls related data according to statistical modules enabling to process the data associated to each advertiser to output statistics enabling the user to measure the efficiency of the banner as a sales promoter; and
retrieving information from the database allowing advertisers to retrieve and view the resulting processing statistical results

26. The method of claim 20 further comprising inputting the user's phone number in an input field, wherein said number identifies the user's communication device; and pressing a virtual call button to initiate the call from the advertiser to the user,
wherein upon inputting said number and pressing said call button, a call between the advertiser's communication device and the user's communication device is automatically initiated.

27. The method of claim 20 further comprising defining the activation conditions upon which the calling tool is activated,
wherein said customization, updating and creating of banners is carried out using a banner customization tool and a banner manager further enabling advertisers to open and update personal accounts enabling the advertisers to prepay for calls, process and view statistical information regarding calls initiated from each advertiser account.

28. The method of claim 20, wherein once the calling tool is activated, a visual indication, indicating the activated status of the calling tool, is presented, which enables the user to enter an interface to initiate a call from the interface by triggering the indicator and wherein said triggering includes at least one of: hovering with a cursor over the indicator; clicking upon the indicator area.

29. (canceled)

30. The method of claim 20, further comprising collecting and storing data from the user's device while the calling tool is triggered by the user, wherein said data is related to the user's communication device and to the call.

31. An ad banner comprising advertising content and a calling tool, said banner enabling to activate the calling tool, which enables initiating a call between a predefined advertiser's communication device and at least one user's communication device, wherein said banner is operatively associated with a central server enabling to maintain and control the banner and operate the calling tool and advertising content, wherein said calling tool is activated according to at least one predefined activation condition.

32. The ad banner of claim 31, further enables providing an interface enabling the user to input data including at least one identifier associated with the user's communication device for executing a call with the advertiser, wherein said ad banner enables storing the at least one identifier to enable future use of the identifier in multiple calling tools of multiple banners.
